(19) United States
(12) Patent Application Publication
(10) Pub. No.: US 2002/0167963 A1
(43) Pub. Date: Nov. 14, 2002

(54) Method and apparatus for spread spectrum medium access protocol with collision avoidance using controlled time of arrival

(76) Inventor: Mario Joa-Ng, Iselin, NJ (US)

Correspondence Address: Joseph Giordano, Esq., Telcordia Technologies, Inc., 445 South Street 1G112R, Morristown, NJ, 07960, US

(21) Appl. No.: 10/107,677

(22) Filed: Mar. 27, 2002

Related U.S. Application Data
(60) Provisional application No. 60/278,950, filed on Mar. 27, 2001.

(51) Int. Cl. H04L 12/413

(52) U.S. Cl. 370/447; 370/461

(57) ABSTRACT

Methods and systems are provided for communicating data between nodes in a network. A first and second source nodes each sends a request-to-send (RTS) control packet to a destination node. The first source node transmits its RTS packet to the destination node over a common channel at a randomly selected time t₁. The second source node transmits its RTS packet to the destination node over a common channel at a randomly selected time t₂. When the destination node receives the RTS packet, the destination node transmits a clear-to-send (CTS) control packet over the common channel. When the destination node is configured to select the first arriving RTS packet and if the RTS packet from the first source node arrives at the destination node before the RTS packet from the second source node, the destination node transmits a CTS control packet over the common channel that corresponds to the RTS packet of the first source node. On the other hand, when the destination node is configured to select a later arriving RTS packet and if the RTS packet from the first source node arrives at the destination node after the RTS packet from the second source node, the destination node transmits a CTS control packet over the common channel that corresponds to the RTS packet of the first source node. Upon receiving the CTS control packet, the first source node sends data packets to the destination node over a channel assigned only to the first source node. At the second source node, since the received CTS packet does not correspond to the RTS packet of the second source node, the second source node may attempt to transmit another RTS packet to the destination node at a randomly selected time instant t₂ until the destination node returns an appropriate CTS packet.

### CROSS REFERENCE TO RELATED APPLICATION

This application claims the benefit of priority of U.S. provisional application No. 60/278,950 filed on Mar. 27, 2001, entitled “Spread Spectrum Medium Access Protocol with Collision Avoidance Using Controlled Time of Arrival.”

### FIELD OF THE INVENTION

The present invention relates generally to communication networks, and more particularly, to medium access protocols.

### BACKGROUND OF THE INVENTION

The proliferation of wireless communication devices places a strain on existing networks to the point that communicated data has a high propensity of being lost during transmission due to collisions. Using properties of spread spectrum, existing systems have attempted to reduce the occurrence of collisions, and thus, reducing the probability of data being lost during transmission.

Two protocols have been proposed in the art to reduce the effects of data collisions in a network. One is known as the Common-Transmitter-Based (C-T) spread spectrum protocol and the other is known as the Receiver-Transmitter-Based (R-T) spread spectrum protocol. In the C-T protocol, a source node transmits control packets using a common spreading code. The source node then transmits data packets using its own unique spreading code. A destination node monitors the common spreading code to receive control packets when it is idle and then switches to monitor the spreading code of the source node to receive data packets. In the R-T protocol, a source node transmits a control packet over the spreading code of the destination node and then transmits the data packet using its own spreading code. A destination node monitors its spreading code to receive control packets when it is idle and then switches to monitor the spreading code of the source node to receive data packets.

FIG. 1A shows a system, which implements the C-T protocol as described above. System 100A includes source nodes 110 and 120 and a destination node 130. Each of source nodes 110 and 120 transmits a packet stream containing both a control packet over a shared channel and data packets over its transmit channel. In the event either of the packet streams transmitted by nodes 110 and 120 collides with another packet stream, the transmitted information is lost. Similarly, even if a collision does not occur and destination node 130 is busy communicating with another node such that destination node 130 fails to detect the packet streams from source nodes 110 and 120, the packet streams of source nodes 110 and 120 are lost. Since the source node is unable to detect whether the destination node is busy or whether a collision has occurred, the source node will continue to transmit control and data packets to the destination node. As a result, any data transmitted by the source node that encounters a collision or a busy destination node is lost.

FIG. 1B illustrates another system 100B, which resolves conflicts using a technique known as Controlled-Time of Arrival. System 100B, which includes source nodes 110 and 120 and a destination node 130, implements a transmission technique that integrates the C-T protocol with the Controlled-Time of Arrival technique. Source nodes 110 and 120 each select a time instant to start transmitting a control and data packets to node 130. In this manner, source nodes 110 and 120 may control the time at which the transmission from each respective node will arrive at destination node 130. Because of the number of time instants available in system 100B, randomly selected time instants t₁ and t₂ of source nodes 110 and 120 will more likely occur at different instants.

FIG. 1C illustrates a timing diagram for adjusting the transmission time of a packet at a particular time slot, which begins at a time equal to zero. A time slot contains multiple periods of spread spectrum signals where T denotes one period. Each period of spread spectrum signals lasts from [0, T] and is equally spaced into N_{W} time instants.

Although integrating the controlled-time of arrival technique with C-T and R-T protocol may reduce the number of collisions, it does not sufficiently reduce collisions and loss of data because a source node cannot determine whether the control packet is successfully received at a destination node before continuing to transmit data packets.

### SUMMARY OF THE INVENTION

To overcome the above and other disadvantages of the prior art, methods and systems are provided for reducing collisions in communication networks. The present invention combines the best features of the well known in the art Multiple Access with Collision Avoidance (MACA) protocols with the Common Transmitter (C-T) or Receiver Transmitter based (R-T) Spread Spectrum protocols and with the controlled time of arrival technique for sending packets a different instants of the same time slot. Specifically, the Request to Send (RTS) packet and Clear to Send (CTS) response packet negotiation technique from the MACA protocol is used to determine whether the control packets sent in the C-T or R-T protocols have been successfully received. While the use of the controlled time of arrival technique is used to reduce the chance of a collision of the controlled packets from a unknown node entering the network and attempting to communicate.

A network consistent with methods and systems of the present invention includes at least a first node and a second node. The network provides a channel assigned only to the first node for sending data in the network. Information about the first node is transmitted, at a random time, to the second node over a channel other than the assigned channel in the network. When the first node receives a response indicating that the second node will accept data from the first node, the first node sends data to the second node over the assigned channel.

In another aspect of the present invention, an apparatus comprises a transmitter, a receiver, and a processor. The transmitter transmits, at a random time, information about the apparatus to a node in the network over a channel in the network. The receiver receives a response to the transmitted information about the apparatus. Based on the response received by the receiver, the processor instructs the transmitter to send data to the node over another channel assigned only to the apparatus for sending data in the network.

The description of the invention and the following description for carrying out the best mode of the invention should not restrict the scope of the claimed invention. Both provide examples and explanations to enable others to practice the invention. The accompanying drawings, which form part of the description for carrying out the best mode of the invention, show several embodiments of the invention, and together with the description, explain the principles of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

In the Figures:

FIGS. 1A-1C illustrate communications between nodes in a network, in accordance with methods and systems of the prior art;

FIG. 2 is a block diagram of a network, in accordance with methods and systems consistent with the present invention;

FIGS. 3A-3B are block diagrams of communication devices in nodes of a network, in accordance with methods and systems consistent with the present invention;

FIGS. 4A-4C are charts illustrating a common-transmitter technique, in accordance with methods and systems consistent with the present invention;

FIGS. 4D-4F are block diagrams illustrating communications between nodes in a network using the common-transmitter technique, in accordance with methods and systems consistent with the present invention;

FIGS. 5A-5C are charts illustrating a receiver-transmitter technique, in accordance with methods and systems consistent with the present invention; and

FIGS. 5D-5F are block diagrams illustrating communications between nodes in a network using the receiver-transmitter technique, in accordance with methods and systems consistent with the present invention.

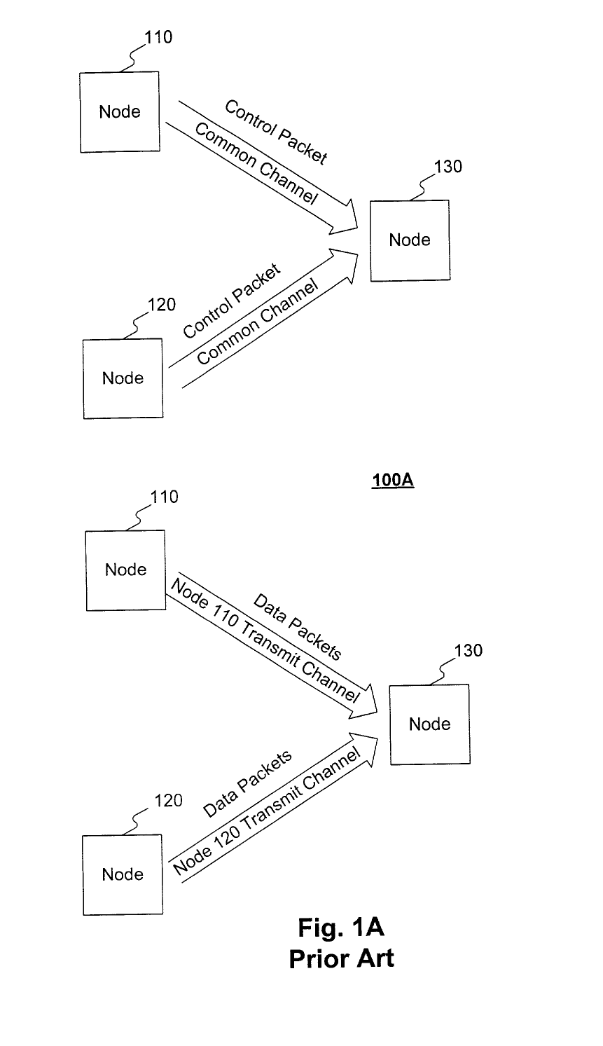

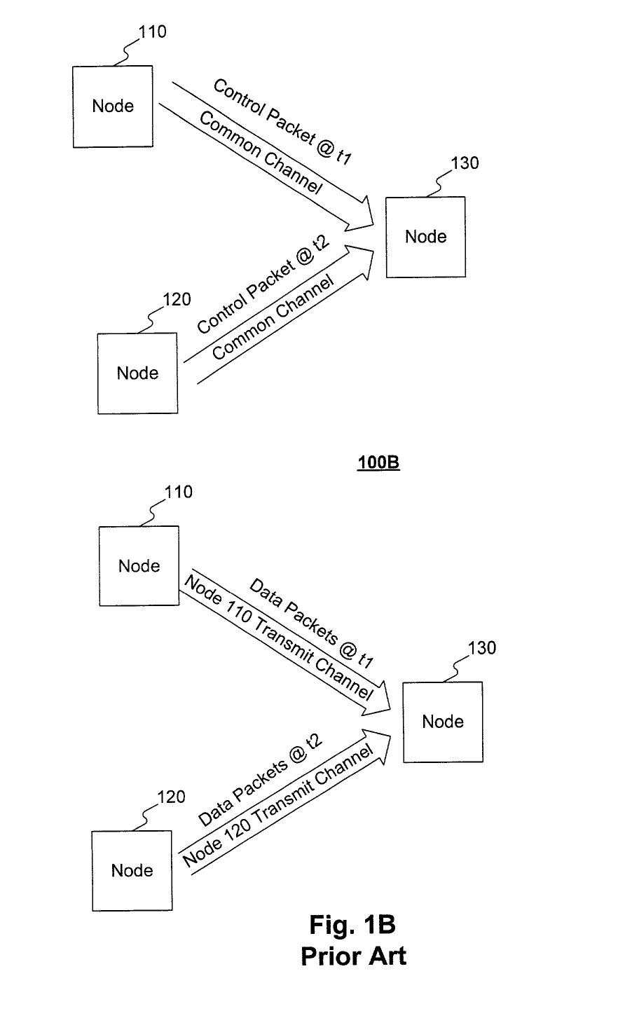

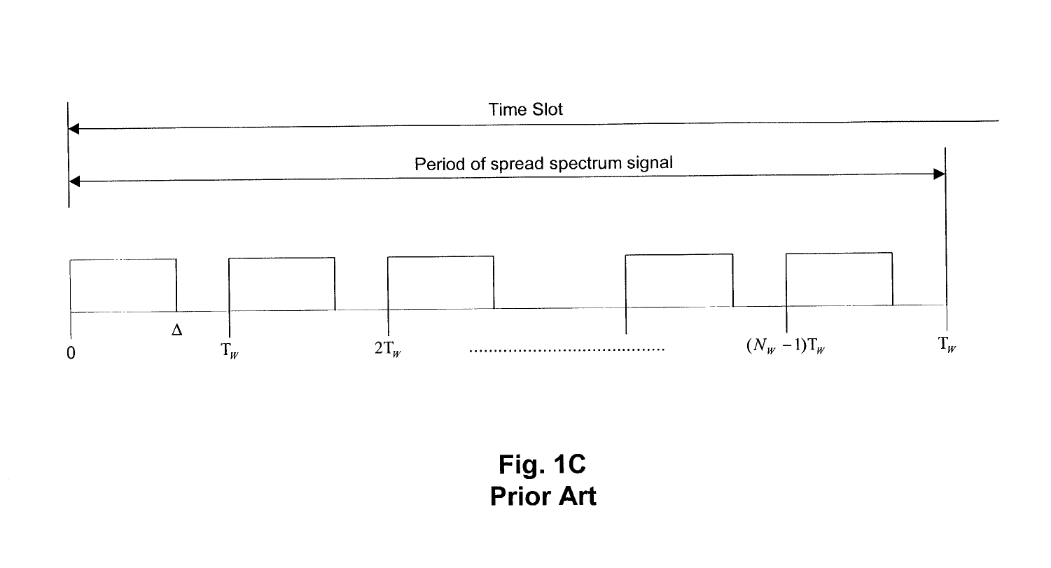

### DESCRIPTION OF THE EMBODIMENTS

Reference will now be made in detail to an implementation of the invention, an example of which is illustrated in the accompanying drawings. Wherever possible, the same reference numbers will be used throughout the drawings to refer to the same or like parts.

Methods and systems are provided for communicating data between nodes in a network. In one embodiment, a source node and a destination node exchange request-to-send (RTS) and clear-to-send (CTS) control packets, respectively. These packets are exchanged to acquire a channel in the network for communicating data. In the event the source node transmits an RTS packet to the destination node over a first channel in the network and the destination node does not return a corresponding CTS packet to the source node, the source node determines that the RTS packet was not received successfully. The source node, however, either enters an idle mode or promptly attempts to retransmit the control packet over the first channel. Otherwise, if the destination node returns to the source node a CTS packet corresponding to the transmitted RTS packet, the source node transmits data packets to the destination node over another channel in the network assigned only to the source node for sending data packets.

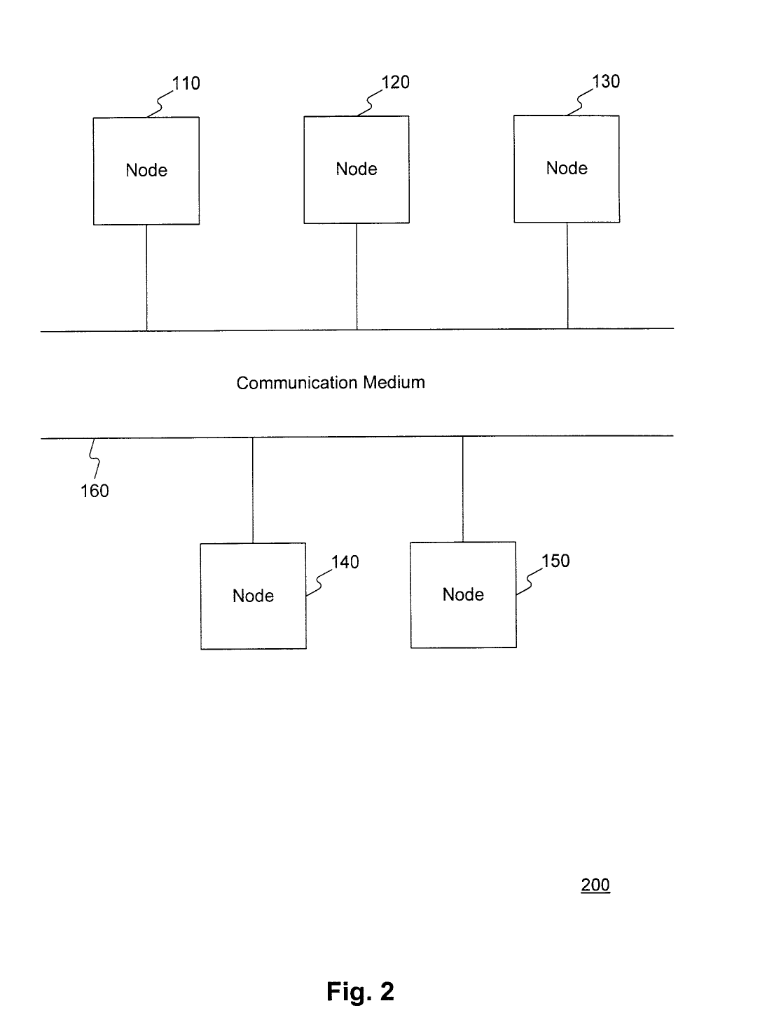

FIG. 2 is a block diagram illustrating a network 200, in accordance with methods and systems consistent with the present invention. Network 200 comprises nodes 110, 120, 130, 140, and 150, all connected via a communication medium 160. Each node 110-150 may include a communication device (not shown), which enables the transfer of information to and from other nodes in network 200. A communication device may be any processor, such as a network device, router, bridge, gateway, personal computer, mobile or wireless telephone, mobile or portable computer, base station, etc. Communication medium 160 may allow nodes 110-150 to communicate over a plurality of channels in network 200 and further include any medium, such as air, cable, wire, fiber, or the like. For the purpose of illustration, however, communication medium 160 in each of the embodiments described below is air.

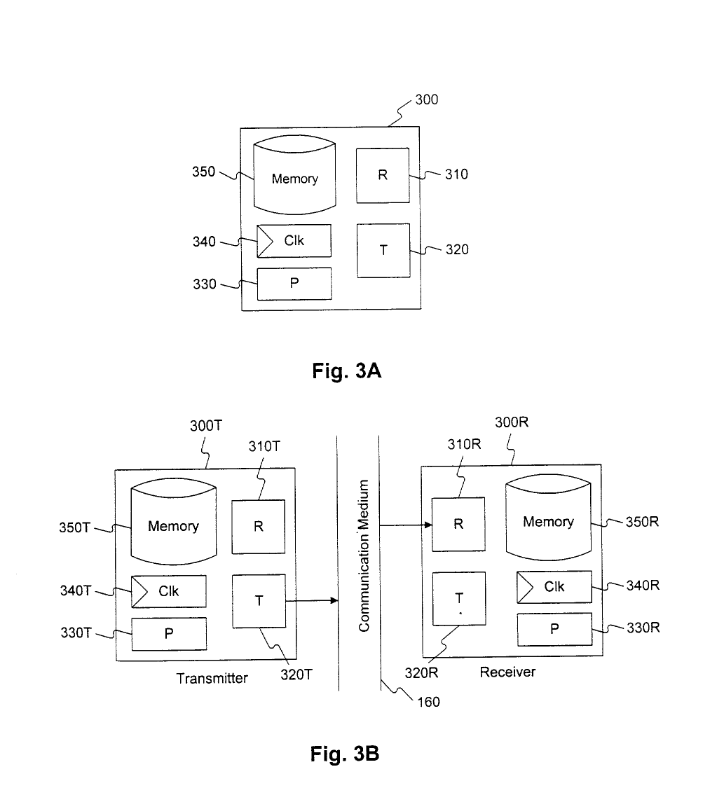

FIG. 3A is a block diagram of a communication device 300 in node 110, in accordance with methods and systems consistent with the present invention. Communication device 300 may include a receiver 310, a transmitter 320, a processor 330, a synchronization clock 340, and a memory 350.

Receiver 310 may monitor communication medium 160 for packets communicated over network 200. Based on instructions received from processor 330, receiver 310 may tune to one of a number of channels in network 200. These channels may include a channel dedicated to node 110, a channel assigned to one of nodes 120-150 in network 200, or a channel shared by node 110 and at least one of nodes 120-150 in network 200.

Transmitter 320 may transmit data packets to other communication devices via communication medium 160. Based on instructions received from processor 330, transmitter 320 may to tune to any one of a number of channels in network 200. These channels may include a channel dedicated to node 110, a channel assigned to one of nodes 120-150 in network 200, or a channel shared by node 110 and at least one of nodes 120-150.

Processor 330 may control the operation of a number of processes and components in communication device 300. Processor 330 may operate in one of three modes, such as an idle mode, a transmit mode, or a receive mode. Processor 330 may also switch between these modes as needed to complete a transaction. Processor 330 may instruct transmitter 320 to tune to a channel in communication medium 160 based on information in a control packet received from another node in network 200, in response to a default setting related to the type of communication scheme employed in network 200, or based on information provided by a user. Similarly, processor 330 may instruct receiver 310 to tune to a specified channel based on information in a control packet received from another node in network 200, or based on a default setting related to the type of communication scheme employed in network 200.

Synchronization clock 340 may synchronize packets transmitted and received by transmitter 320 and receiver 310, respectively so that the reception of packets starts at the beginning of one time slot and ends before the next time slot in receiver 310. In a controlled time of arrival scheme, synchronization clock 340 may further divide the first period of spread spectrum signals in each time slot into a number of equally spaced time instants tᵢ. Synchronization clock 340 may use any time instant in triggering transmitter 320 to transmit packets. Synchronization clock 340 may control the time of arrival of each packet in a manner so that packets transmitted at different time instants tₓ during the same time slot are resolved even if the packets are transmitted over the same channel.

Memory 350 may include a table that stores information identifying each of nodes 110-150 and the corresponding channel assigned to each node in network 200 for communicating over communication medium 160.

FIG. 3B shows a block diagram illustrating the active components of communication devices 300T and 300R in nodes 110 and 130, respectively, in accordance with methods and systems consistent with the present invention. Communication device 300T, which may operate in a transmit mode, may include transmitter 320T, processor 330T, synchronization clock 340T, and memory 350T. Communication device 300R, which may operate in a receive mode, may include receiver 310R, processor 330R, synchronization clock 340R, and memory 350R. Communication device 300R may also operate in an idle mode, wherein receiver 310R monitors a selected channel in communication medium 160 for packets whose destination address match the network address of the node 130 where communication device 300R resides. Processor 330 of either communication device 300T or 300R may switch between the transmit, receive, or idle mode as needed to successfully complete a transaction.

In an effort to avoid loss of packet transmissions due to collisions and interference, communication devices 300T and 300R may integrate the well-known R-T and C-T spread spectrum protocols with multiple access with collision avoidance (MACA) protocol.

In a MACA system, a source node desiring to communicate with a destination node in the network 200 may exchange request-to-send (RTS) and clear-to-send (CTS) control packets with the destination node. Both the RTS and CTS packets have a number of fields including a source id, a destination id, and length of a data packet. Only after a successful exchange of these control packets may the source node transmit a data packet to the destination node. Integrating MACA, C-T and R-T spread spectrum protocols, and the controlled time of arrival transmission scheme, allows the source node to detect whether the destination node is busy or whether a collision has occurred. Unsuccessful RTS transmissions prevent the source node from transmitting data to an unavailable destination node and allow the source node to prepare instead for retransmitting another RTS packet during the next time slot.

In a spread spectrum embodiment, the RTS and CTS dialogue may be completed within the duration of one time slot. The period T of spread spectrum signals may only occupy a portion of the total duration of the time slot. The first period of spread spectrum signals in a time slot is further divided into N_{W} equally spaced time instants over its duration [0, T]. The source node chooses with equal probability one of N_{W} time instants, corresponding to time instants {tᵢ}ᵢ₌₀^{N}^{_{W-1}} to start the transmission in a time slot. The packet transmitted at a time instant tᵢ may arrive at the receiver within the time range [iT_{W}, iT_{W}+Δ], where the total time delay A includes the timing drift and propagation delay. In the controlled time of arrival technique, synchronization clock 340 may adjust the transmission time of a packet by randomly choosing one of N_{W} time instants that are equally spaced over one period of the spread spectrum signals at the beginning of a time slot. The size of the time slot is determined such that the entire RTS-CTS dialogue is accommodated.

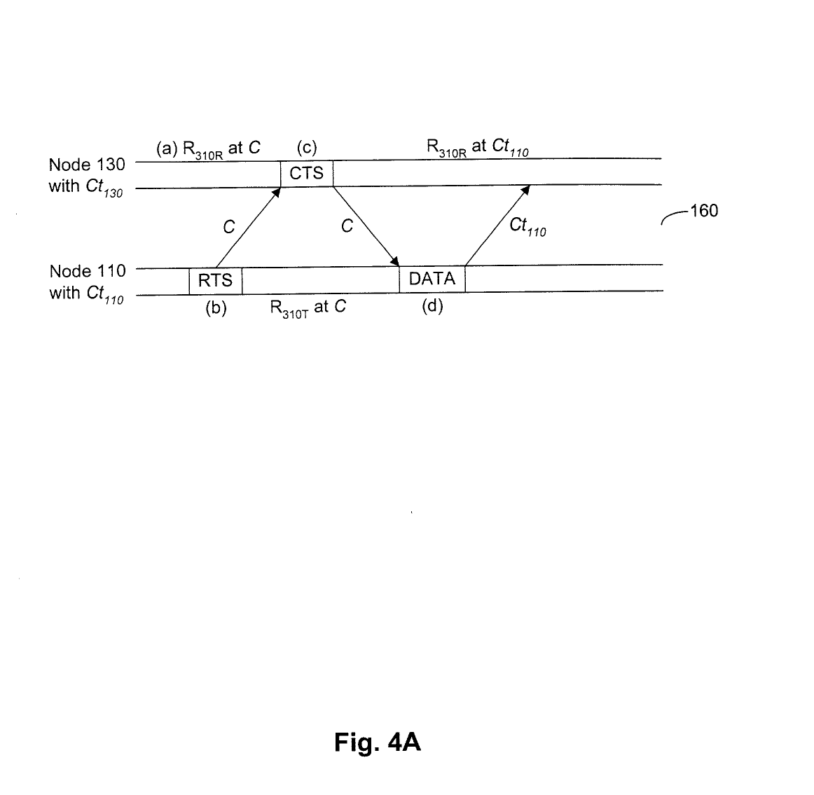

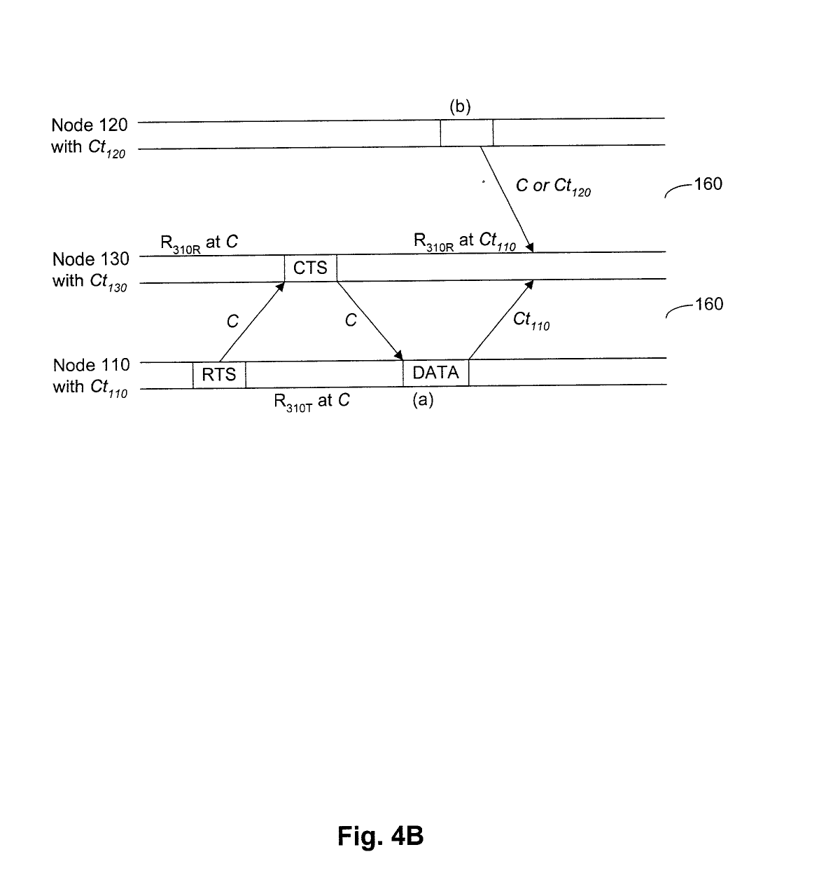

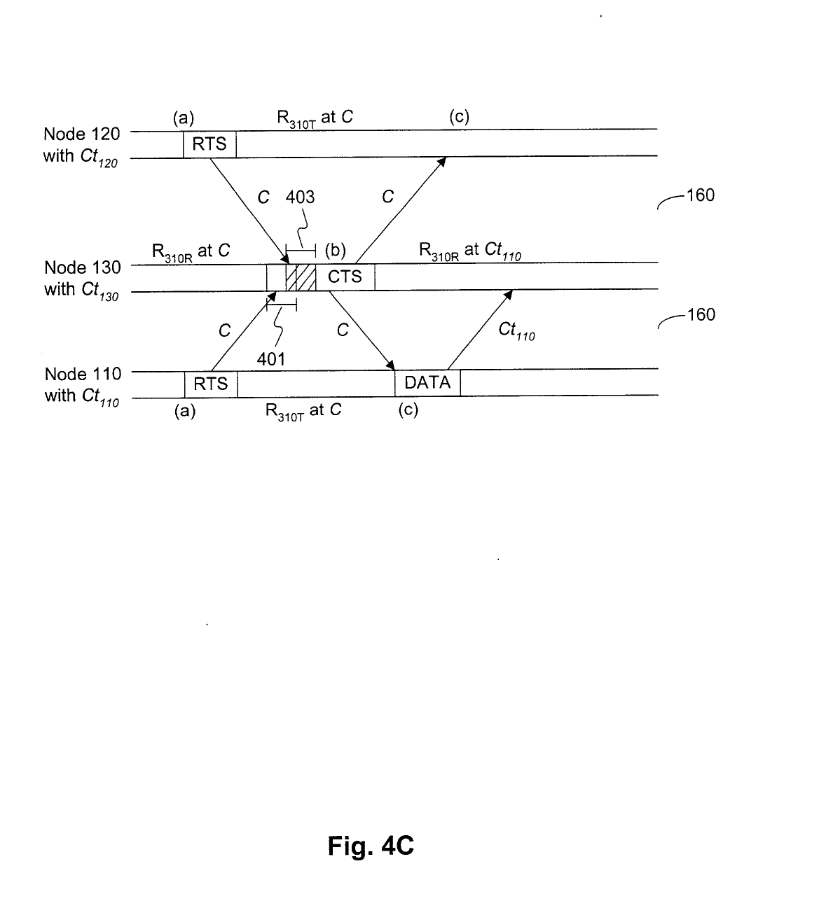

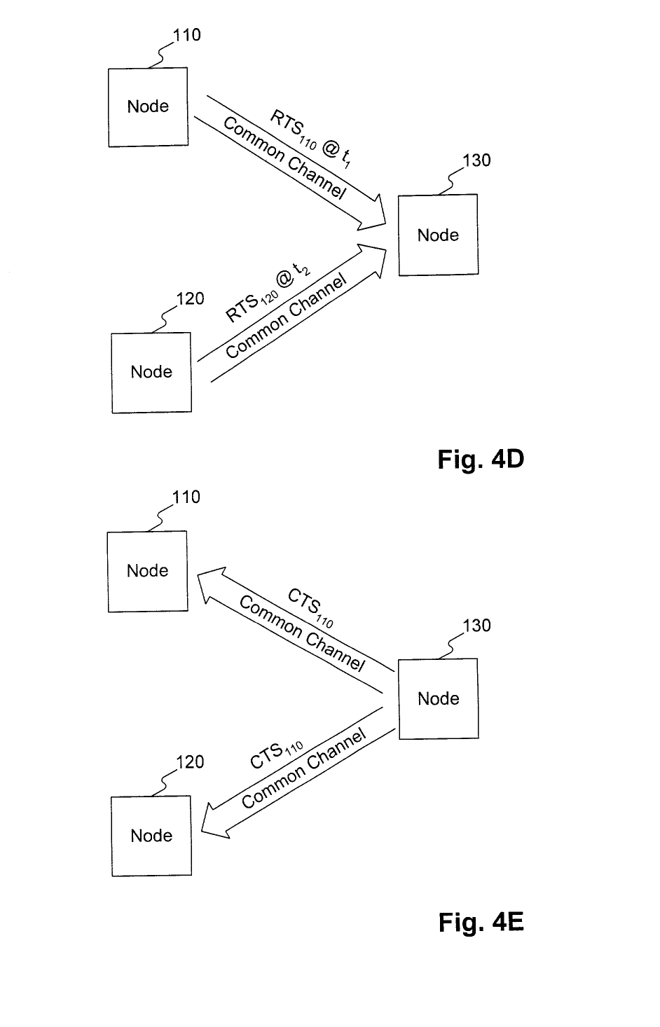

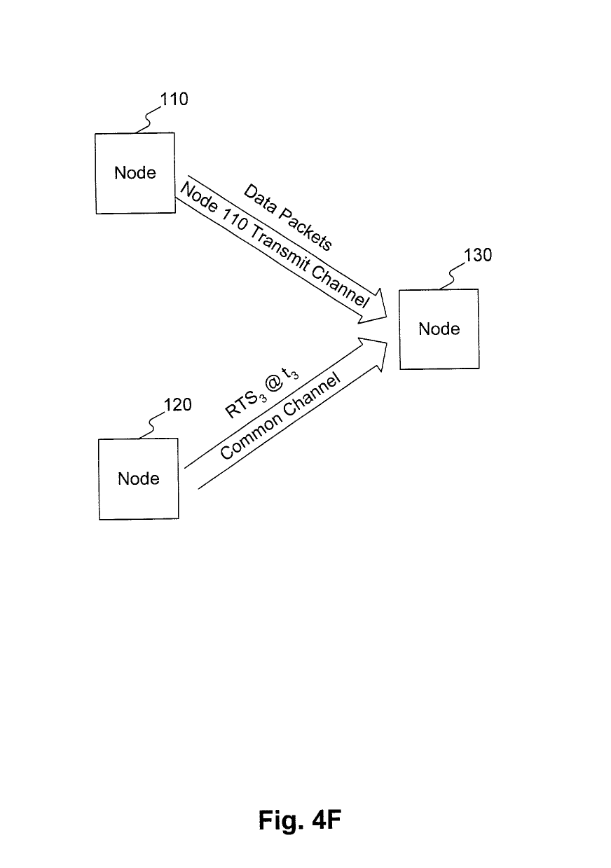

FIG. 4A shows communication between nodes 110 and 130 using a multiple access collision avoidance/controlled time of arrival/common-transmitter (MACA/CTOA/C-T) protocol, in accordance with methods and systems consistent with the present invention.

At time (a), processor 330T of node 130 may operate in an idle mode. Receiver 310R may monitor the shared channel C for an RTS packet that identifies the network address of node 130 in the destination field of the packet. At time (b), processor 330T in node 110 may operate in a transmit mode and may tune transmitter 320T to the shared channel C. Transmitter 320T may then transmit an RTS packet to node 130 via communication medium 160. The source and destination fields of the RTS packet identify the network address of node 110 and the network address of node 130, respectively. After the RTS packet is transmitted to node 130, processor 330T switches to the receive mode and tunes receiver 310T to the shared channel C so that a CTS packet may be received from node 130.

At time (c), receiver 310R in node 130 receives the RTS packet from node 110 over the shared channel C. Processor 330R may switch to the transmit mode and may instruct transmitter 320R to transmit a CTS packet to node 110. Transmitter 320R may transmit the CTS packet to node 110, and processor 330R may switch to the receive mode. Processor 330R may tune receiver 310R to a channel Ct₁₁₀, which is assigned only to node 110 for transmitting data packets.

At time (d), receiver 310T of node 110 may receive the CTS packet from node 130. Processor 330T may switch to the transmit node and tune transmitter 320T to channel Ct₁₁₀. Transmitter 320T may then transmit data packets to node 130 via communication medium 160.

FIG. 4B illustrates general operation of MACA/CTOA/C-T protocol when an intruder enters the reception range of a busy node, in accordance with methods and systems consistent with the present invention. In FIG. 4B, nodes 110 and 130 successfully complete the RTS-CTS dialogue as shown prior to time (a). As discussed above, transmitter 320T of node 110 may transmit data packets to node 130 over a channel Ct₁₁₀, which is assigned only to node 110 for transmitting data packets. At time (b), transmitter 320T in node 110 may transmit data packets to node 130 over the channel Ct₁₁₀ (see time (a)), and transmitter 320T in node 120 may also attempt to transmit information to node 130. In the MACA/CTOA/C-T scheme, transmitter 320T in node 120 may transmit an RTS or CTS packet to node 130 over the shared channel C and may transmit a data packet over a channel Ct₁₂₀ assigned only to node 120. In either instance, the packet(s) sent from node 120 to node 130 will not collide with the data packets sent from node 110 to node 130 because the two transmissions are sent over separate channels in network 200.

FIG. 4C illustrates a controlled time of arrival scheme for a MACA/CTOA/C-T protocol in accordance with methods and systems consistent with the present invention. Initially, processor 330R in node 130 may operate in an idle mode, and receiver 310R may monitor the shared channel C. At time (a), each node 110 and 120 may desire to transmit data to node 130. The process for sending a control packet via the channel is the same for each node 110 and 120. Processor 330T in node 110 may operate in a transmit mode and may tune transmitter 320T to the shared channel C of network 200. Transmitter 320T in conjunction with synchronization clock 340T may transmit an RTS packet to node 130 over communication medium 160 at a randomly selected time instant. After transmitter 320T transmits the RTS packet to node 130, processor 330T may switch to the receive mode. In the receive mode, processor 330T may tune receiver 310T to the shared channel C so that a CTS packet may be received from node 130 over communication medium 160.

At time (b), the unshaded region 401 and the shaded region 403 designate the durations of the reception of a RTS packet at node 130 from nodes 110 and 120, respectively. As indicated by the unshaded and shaded regions 401 and 403, the RTS packets received at node 130 may overlap, and the RTS packet from node 110 may arrive at node 130 before the RTS packet from node 120. As a result, processor 330R in node 130 may switch to the transmit mode and may tune its transmitter to the shared channel C. Transmitter 320R may transmit a CTS packet using the shared channel C, and processor 330R may tune receiver 310R to channel Ct₁₁₀, which is assigned only to node 110 for transmitting data packets. Processor 330R may select channel Ct₁₁₀ because the RTS packet identifying node 110 as the source arrived at the receiver of node 130 before the RTS packet identifying node 120 as the source. Alternatively, processor 330R may be configured to select the channel of the RTS packet that is not the first to arrive at the receiver of node 130. In such a configuration, after transmitter 320R transmits the CTS packet using the shared channel C, processor 330R may tune receiver 310R to channel Ct₁₂₀, which is assigned only to node 120 for transmitting data packets.

At time (c), each node 110 and 120 may receive a CTS packet from node 130 over the shared channel C. The destination field of each received CTS packet may identify the network address of node 110. As a result, processor 330T in node 110 may switch to the transmit mode and tune transmitter 320T to the channel Ct₁₁₀, which is assigned only to node 110 for transmitting data packets. Transmitter 320T may then transmit data packets to node 130 using the channel Ct₁₁₀. Because the destination field of each received CTS packet does not identify the network address of node 120, node 120 may not transmit data packets to node 130. But processor 330T in node 120 may instead switch to the idle mode at the beginning of the next time slot and thereafter switch again to the transmit mode during the same time slot. In this manner processor 330T may instruct transmitter 320T to retransmit an RTS packet to node 130 during a randomly selected time instant tₓ.

FIGS. 4D-4F illustrate control and data packets communicated between nodes 110, 120, and 130 in network 200 using the MACA/CTOA/C-T protocol in accordance with methods and systems consistent with the present invention.

In FIG. 4D, each node 110 and 120 may desire to transmit data packets to node 130. In order to acquire access to a channel, each node 110 and 120 may transmit an RTS packet and receive in return a CTS packet from node 130. Particularly, processor 330T in node 110 may instruct transmitter 320T to tune to the shared channel C of network 200 so that control packet RTS₁₁₀ can be transmitted to node 130 over communication medium 160. Next, processor 330T may instruct transmitter 320T to transmit RTS₁₁₀ to node 130 over communication medium 160.

After receiving instructions from processor 330T to transmit RTS₁₁₀ to node 130, transmitter 330T may coordinate the transmission of RTS₁₁₀ with synchronization clock 340T. Synchronization clock 340T may trigger transmitter 330T to transmit RTS₁₁₀ to node 130 at a randomly selected time instant t₁. At node 120, synchronization clock 340T may trigger transmitter 320T to transmit RTS₁₂₀ to node 130 at a randomly selected time instant t₂.

Once transmitter 320T in node 110 transmits RTS₁₁₀ to node 130, processor 330T may switch to the receive mode. Processor 330T may then instruct receiver 310T to tune to the shared channel C in network 200, enabling node 110 to receive a CTS packet corresponding to the RTS packet node 110 transmitted to node 130.

In FIG. 4E, RTS₁₁₀ transmitted from node 110 at a randomly selected time instant t₁ is received by receiver 330R in node 130 before RTS₁₂₀ transmitted from node 120 at a randomly selected time instant t₂. As a result, processor 330R of node 130 may switch to the transmit mode. Processor 330R may then instruct transmitter 320T to tune to the shared channel and transmit CTS₁₁₀ using the shared channel. Transmitter 320R may transmit CTS₁₁₀ over the shared channel, and processor 330R may switch to the receive mode. In the receive mode, processor 330R may access memory 350R to identify the channel assigned only to node 110 for transmitting data packets. Once processor 330R identifies the transmit channel assigned to node 110, processor 330R may instruct receiver 310R to tune to the transmit channel of node 110 so that data packets can be received from node 110.

In FIG. 4F, the destination field of CTS₁₁₀ from node 130 may identify the network address of node 110. As a result, processor 330T in node 110 may instruct transmitter 320T to tune to the transmit channel assigned only to node 110 for transmitting data packets. Following the instructions of processor 330T, transmitter 320T may tune to the transmit channel to transmit data packets to node 130.

Conversely, any other node that may be monitoring the shared channel may receive CTS₁₁₀ from node 130. These other nodes, however, will not respond to the received transmission because the destination field of CTS₁₁₀ does not identify their respective network addresses. Particularly, the destination field in CTS₁₁₀ does not identify the network address of node 120. Therefore, processor 330T in node 120 may switch to the idle mode. During the next time slot, processor 330T may switch to the transmit mode, instruct transmitter 320T to tune to the shared channel, and transmit an RTS packet to node 130. Transmitter 320T may then attempt to retransmit, at a randomly selected instant of the next time slot, an RTS packet to node 130 using the shared channel. Processor 330T may repeat the send instruction to transmitter 320T until node 120 receives a CTS₁₂₀ packet from node 130.

In another embodiment, network 200 implements a multiple access collision avoidance/controlled time of arrival/receiver-transmitter (MACA/CTOA/R-T) protocol. MACA/CTOA/R-T uses the pre-specified channels that are assigned to each respective node for communicating over communication medium 160. For example, nodes 110-150 in network 200 may be preassigned at least two unique channels. One of the assigned channels may be used for receiving information over communication medium 160 and the other may be used for transmitting information over communication medium 160. MACA/CTOA/R-T uses the unique transmitting and receiving channels assigned to a node to communicate information over communication medium 160.

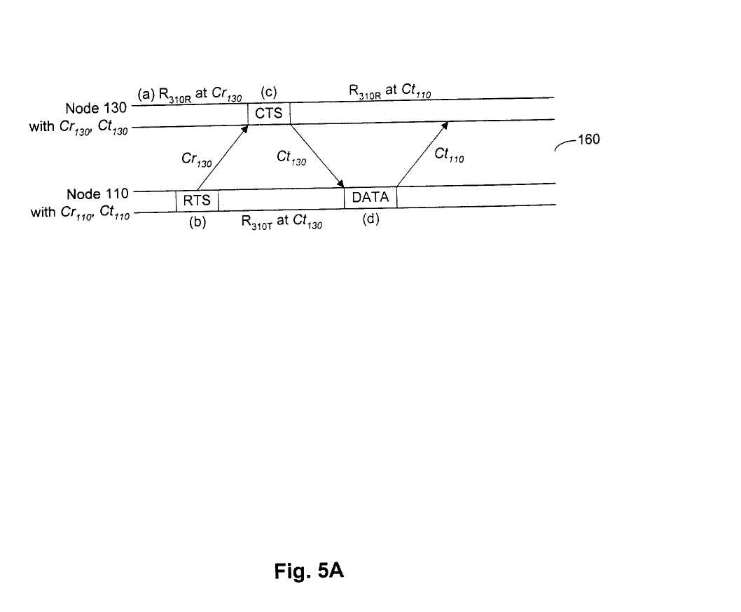

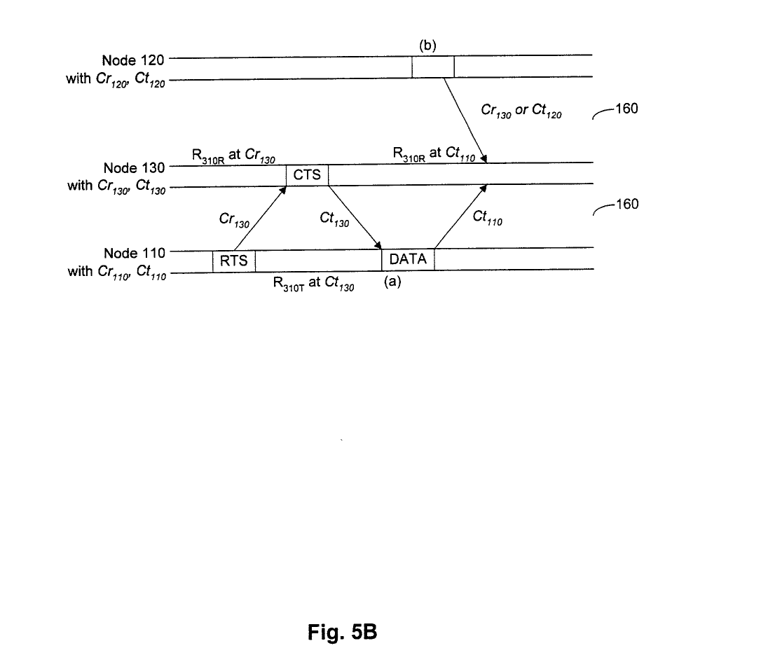

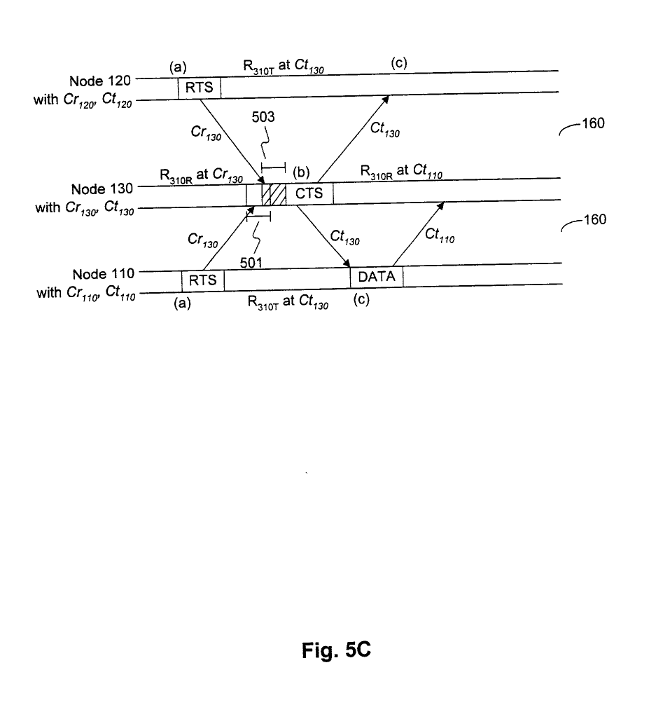

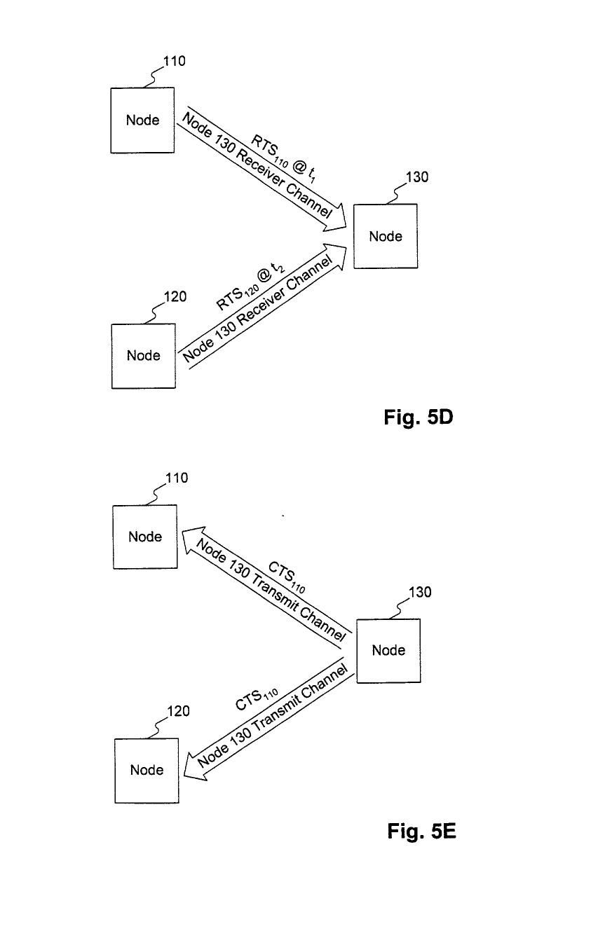

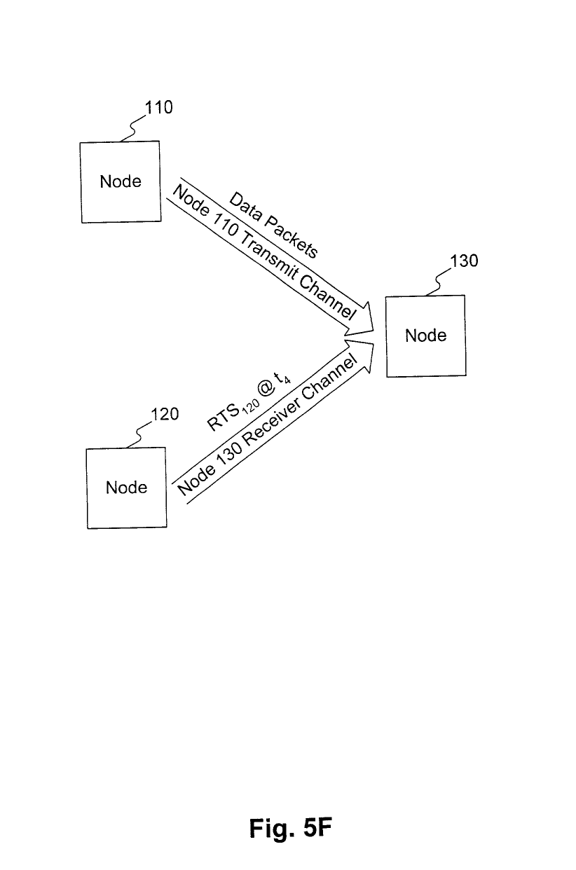

FIG. 5A shows data communication between two nodes 110 and 130 in a network using MACA/CTOA/R-T, in accordance with methods and systems consistent with the present invention. At time (a), processor 330R in node 130 operates in an idle mode and monitors a channel assigned only to node 130 for receiving information over communication medium 160. At time (b), processor 330T in node 110 may desire to initiate communications with node 130 and, therefore, may tune transmitter 320T to a channel Cr₁₃₀, which is assigned only to node 130 for receiving information. Transmitter 320T may then transmit an RTS packet to node 130 using channel Cr₁₃₀. After transmitting the RTS packet to node 130, processor 330T may switch to the receive mode. In the receive mode, processor 330T may tune receiver 310T to a channel Ct₁₃₀, which is assigned only to node 130 for transmitting information, so that a CTS packet from node 130 may be received over communication medium 160.

At time (c), receiver 310R in node 130 receives the RTS packet from node 110. Processor 330R in node 130 may switch to the transmit mode and then tune transmitter 320R to channel Ct₁₃₀. Transmitter 320R may transmit a CTS packet to node 110 using channel Ct₁₃₀. After transmitter 320R transmits the CTS packet to node 110, processor 330R may switch to the receive mode and then tune receiver 310R to the channel Ct₁₁₀ so that data packets can be received over communication medium 160.

At time (d), receiver 310T in node 110 may monitor the transmit channel Ct₁₃₀ and receive the CTS packet. Processor 330T may switch to the transmit mode and tune transmitter 320T to channel Ct₁₁₀. Accordingly, transmitter 320T may transmit data packets to node 130 over communication medium 160.

FIG. 5B illustrates MACA/CTOA/R-T protocol when an intruder enters the reception range of a busy node, in accordance with methods and systems consistent with the present invention. In FIG. 5B, nodes 110 and 130 successfully complete the RTS-CTS dialogue as discussed above, and receiver 310R in node 130 is busy receiving data packets from node 110 over the transmit channel Cr₁₁₀, which is assigned only to node 110 for receiving information. At time (b), node 120 may desire to transmit information to node 130 at the same time node 130 is busy receiving data packets from node 110 over the channel Ct₁₁₀. Processor 330T in node 120 may access channel assignment data stored in memory 350T and select one of the channels for transmitting information to node 130 over communication medium 160. Based on the available channels in network 200, node 120 may transmit a RTS packet to node 130 over channel Cr₁₃₀, which is assigned only to node 130 for receiving information. Node 120 may also transmit a CTS or data packet to node 130 over a channel Ct₁₂₀, which is assigned only to node 120 for transmitting CTS or data packets. In either instance, the packet(s) sent from node 120 to node 130 will not collide with the data packets transmitted from node 110 to node 130, as the two transmissions are sent over different channels.

FIG. 5C illustrates MACA/CTOA/R-T protocol using a controlled time of arrival communication scheme, in accordance with methods and systems consistent with the present invention. Initially, processor 330R in node 130 may operate in an idle mode, and receiver 310R may monitor a channel Cr₁₃₀ assigned only to node 130 for receiving information over communication medium 160. At time (a), processor 330T in node 110 may operate in the transmit mode and tune transmitter 320T to channel Cr₁₃₀, which is assigned only to node 130. Transmitter 320T may then transmit an RTS packet to node 130 using channel Cr₁₃₀. The RTS packet from node 110 identifies the network address of node 110 as the source and the network address of node 130 as the destination. Similarly, the RTS from node 120 identifies the network address of node 130 as the destination, but identifies the network address of node 120 as the source.

At time (b), the unshaded region 501 and the shaded region 503 designate the duration of the reception of a RTS packet at node 130 from nodes 110 and 120, respectively. As shown by the unshaded and shaded regions 501 and 503 the RTS packets received at node 130 may overlap, and the RTS packet from node 110 arrives at node 130 before the RTS packet from node 120. As a result, processor 330R may switch to the transmit mode and tune transmitter 320R to the channel Ct₁₃₀, which is assigned only to node 130 for transmitting information over communication medium 160. Transmitter 320R may then transmit to node 110 a CTS packet identifying the network address of node 110 as the destination node. After transmitter 320R transmits the CTS packet over its channel Ct₁₃₀, processor 330R may switch to the receive mode and then tune receiver 310R to a channel Ct₁₁₀, which is assigned only to node 110 for transmitting data packets. Alternatively, processor 330R may be configured to select the channel of the RTS packet that is not the first to arrive at the receiver of node 130. In such a configuration, processor 330R may switch to the transmit mode and tune transmitter 320R to the channel Ct₁₃₀. Transmitter 320R may then transmit to node 120 a CTS packet identifying the network address of node 120 as the destination node.

At time (c), nodes 110 and 120 both receive a CTS packet from node 130 over the channel Ct₁₃₀. But because the destination field of the received CTS packet identifies the network address of node 110 as the destination, processor 330T of node 110 switches to the transmit mode and tunes transmitter 320T to the channel Ct₁₁₀, which is assigned only to node 110 for transmitting data packets. Transmitter 320T may then transmit data packets to node 130 using channel Ct₁₁₀.

Because the destination field of the received CTS packet does not identify the network address of node 120 as the destination, node 120 may not transmit data packets to node 130. Processor 330T of node 120 may instead switch to the idle mode at the beginning of the next time slot and thereafter switch again to the transmit mode during the same time slot. In this manner, processor 330T may instruct transmitter 320T to retransmit an RTS packet to node 130 during a randomly selected time instant tₓ.

FIGS. 5D-5F illustrate a MACA/CTOA/R-T protocol using a controlled time of arrival communication scheme, in accordance with methods and systems consistent with the present invention. In FIG. 5D, each node 110 and 120 transmits a unique RTS packet to node 130 over the receiver channel. In transmitting RTS₁₁₀, processor 330T in node 110 may access memory 350T to determine the channel assigned to node 130 for receiving information over communication medium 160. After processor 330T identifies the receiver channel, processor 330T may instruct transmitter 320T to tune to the identified receiver channel and transmit RTS₁₁₀ over that channel.

After receiving instructions from processor 330T to transmit RTS₁₁₀ over the receiver channel, transmitter 320T may coordinate the transmission of RTS₁₁₀ with synchronization clock 340T. Synchronization clock 340T may trigger transmitter 330T to transmit RTS₁₁₀ over the receiver channel at a randomly selected time instant t₁.

At node 120, however, synchronization clock 340T may trigger transmitter 320T to transmit RTS₁₂₀ over the receiver channel assigned only to node 130 at a randomly selected time instant t₂. Once transmitter 320T in node 110 transmits RTS₁₁₀ to node 130, processor 330T may switch to receive mode. Processor 330T may access memory 350T to determine the channel assigned only to node 130 for sending information over communication medium 160. When processor 330T identifies the transmit channel, processor 330T may instruct receiver 310T to tune to the transmit channel so that a CTS packet may be received over communication medium 160. In other words, if RTS₁₁₀ is successfully received at node 130, then node 130 in return transmits CTS₁₁₀to node 110. Likewise, if RTS₁₂₀ is successfully received by node 130, then node 130 transmits CTS₁₂₀ to node 120.

In FIG. 5E, RTS₁₁₀ transmitted from node 110 at the randomly selected time instant t, may arrive at node 130 before the RTS packet transmitted from node 120 at the randomly selected instant t₂. As a result, processor 330R in node 130 may switch to the transmit mode and then instruct transmitter 320T to tune to the transmit channel assigned only to node 130 and transmit CTS₁₁₀ over communication medium 160. The source field and destination field of CTS₁₁₀ identify the network addresses of nodes 130 and 110, respectively. After transmitter 320T transmits CTS₁₁₀, processor 330R may switch to receive mode. Processor 330R may then access memory 350R to identify the channel assigned only to node 110 for transmitting data packets over communication medium 160. Once processor 330R identifies the transmit channel, processor 330R may instruct receiver 310R to tune to that channel so that data packets are successfully received from node 110.

In FIG. 5F, after receiver 310T in node 110 receives CTS₁₁₀ from node 130, processor 330T switches to the transmit mode. Processor 330T may then instruct transmitter 320T to tune to the transmit channel assigned only to node 110, and transmit data packets to node 130 over communication medium 160. Transmitter 320T may then tune to the identified transmit channel and transmit data packets to node 130 using that channel.

Additionally, other nodes in network 200 may be monitoring the transmit channel assigned to node 130. These other nodes may too receive CTS₁₁₀ from node 130. However, the other nodes will not respond to the received transmission because the destination field of CTS₁₁₀ does not identify the respective network addresses of these other nodes. Particularly, because the destination field of CTS₁₁₀ does not identify node 120, processor 330T in node 120 determines that RTS₁₂₀ was not received successfully at node 130. Therefore, processor 330T may attempt to retransmit an RTS₁₂₀ packet to node 130. In doing so, processor 330T may switch to the idle mode at the beginning of the next time slot and thereafter switch to the transmit mode during the same time slot. In this manner, processor 330T may instruct transmitter 320T retransmit an RTS packet to node 130 using the receiver channel assigned to node 130 during a randomly selected time instant tₓ.

As should be understood from the MACA/CTOA/R-T embodiment above, an RTS-CTS exchange may be successfully completed so long as the RTS packet is targeted to an idle node. Because the RTS packets are transmitted on receiver-based channels unique to each node in network 200, multiple packets do not collide if they are targeted to different receivers. Therefore, multiple RTS-CTS exchanges may occur at the same time instant of the same time slot in the network. Moreover, if multiple nodes send packets to the same node at the same randomly selected time instant, they quickly detect the collision and prepare to resend a new RTS packet during the next time slot.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for communicating in a network including at least a first node and a second node, the method comprising:
providing a channel assigned only to the first node for sending data in the network;
sending, at a first random time, information about the first node to the second node over a channel other than the assigned channel of the first node;
receiving, at the first node, a response to the information about the first node; and
the first node sending data to the second node over the assigned channel of the first node when the received response indicates that the second node accepts data from the first node.

2. The method of claim 1, wherein the received response indicates that the second node accepts data from the first node when the second node receives the information about the first node before receiving information about another node desiring to communicate with the second node.

3. The method of claim 2, further comprises:
determining the assigned channel of the first node; and
adjusting a transmitter in the first node to enable the first node to send data to the second node over the assigned channel of the first node.

4. The method of claim 1, further comprising:
the first node resending, at a second random time, the information about the first node to the second node over the other channel when the received response indicates that the second node rejects receiving data from the first node.

5. The method of claim 4, wherein the received response includes information indicating that the second node rejects receiving data from the first node when the second node receives the information about the first node after receiving information about another node desiring to communicate with the second node.

6. The method of claim 4, wherein the received response includes information indicating that the second node rejects receiving data from the first node when the second node receives the information about the first node before receiving information about another node desiring to communicate with the second node.

7. The method of claim 1, wherein sending information about the first node to the second node further comprises:
determining that the other channel is assigned only to the second node for receiving information in the network; and
adjusting a transmitter in the first node to enable the first node to send the information about the first node over the other channel.

8. The method of claim 1, wherein receiving the response to the information about the first node further comprises:
identifying a channel assigned only to the second node for communicating in the network; and
adjusting a receiver in the first node to enable the first node to receive the response from the second node over the assigned channel of the second node.

9. The method of claim 1, wherein the received response indicates that the second node accepts data from the first node when the second node receives the information about the first node after receiving information about another node desiring to communicate with the second node.

10. An apparatus, comprising:
a transmitter that transmits, at a random time, information about the apparatus to a node in the network over a first channel in the network;
a receiver that receives a response to the transmitted information about the apparatus; and
a processor that based on the response received by the receiver instructs the transmitter to transmit data to the node over another channel assigned only to the apparatus for transmitting data in the network.

11. The apparatus of claim 10, further comprising:
a memory that includes information indicating that the first channel is assigned only to the node for receiving communications in the network.

12. The apparatus of claim 11, wherein the processor instructs the transmitter to tune to the first channel to transmit information about the apparatus to the node.

13. The apparatus of claim 10, further comprising:
a memory that includes information identifying a channel assigned only to the node for transmitting communications in the network.

14. The apparatus of claim 13, wherein the processor instructs the receiver to tune to the assigned channel of the node to receive the response from the node.

15. The apparatus of claim 10, wherein the processor instructs the transmitter to retransmit information about the apparatus to the node when the received response indicates that the node rejects receiving data from the apparatus.

16. The apparatus of claim 10, wherein the processor instructs the receiver to tune to the first channel to receive the response from the node.

17. The apparatus of claim 10, wherein the processor instructs the transmitter to tune to the other channel to transmit data to the node.

18. The apparatus of claim 10, wherein the processor instructs the transmitter to transmit data to the node when the received response indicates that the node accepts receiving data from the apparatus.

19. A method for communicating in a network including at least a first node and a second node, the method comprising:
providing a channel assigned only to the first node for sending data in the network;
receiving, at a random time, from the first node information about the first node over a channel other than the assigned channel in the network;
sending to the first node a response that indicates that the first node can send data to the second node over the assigned channel; and
receiving from the first node data over the assigned channel.

20. A system comprising:
a first node that sends, at a random time, information about the first node over a channel in the network; and
a second node that receives the information about the first node and sends a response to the first node;
wherein the first node sends data to the second node over another channel assigned only to the first node for sending data in the network when the response indicates that the second node accepts data from the first node.
